(19) United States
(12) Patent Application Publication
(10) Pub. No.: US 2005/0007345 A1
(43) Pub. Date: Jan. 13, 2005

(54) Power saving device

(76) Inventor: Yen-Liang Kuan, Taipei (TW)

Correspondence Address: Chiaoyun Kuo, Ph.D.;Bayshore Patent Group, LLC, 520 Chantecler Dr., Fremont, CA, 94539, US

(21) Appl. No.: 10/914,100

(22) Filed: Aug. 9, 2004

Related U.S. Application Data
(63) Continuation-in-part of application No. 10/082,298, filed on Feb. 26, 2002.

(51) Int. Cl. G09G 5/08

(52) U.S. Cl. 345/163

(57) ABSTRACT

The present invention is a power saving device disposed in a mouse and comprises at least one sensor in communication with both battery and a signal emitter. The sensor is located within the mouse housing and is disposed under a window. When the user holds the mouse and blocks the window, the sensor receives a correct signal and connects to the operating power supply of the signal emitter to make the mouse operate normally. When the user does not use the computer for a while and the mouse is in a suspending mode, the sensor receives an incorrect signal to disconnect from the operating power supply so the signal emitter of the mouse does not need to perform scanning continuously any more, thus decreasing power consumption.

### CROSS REFERENCE TO RELATED APPLICATIONS

This application is a continuation-in-part application of U.S. application Ser. No. 10/082,298 filed Feb. 26, 2002; all of which are herein incorporated by reference in their entirety.

### BACKGROUND OF THE INVENTION

1. Field of the Invention

The present invention relates to a power saving device, more particularly to a device applied to a mouse. The signal emitter of the mouse does not need to scan continuously in the suspending mode. Since only a very small amount of power is consumed, the life of the battery is increased significantly.

2. Description of the Prior Art

A wireless mouse needs an independent battery as an operation power supply for the signal emitter. In addition to the signal emitter that performs scanning continuously in the suspending mode, the battery supplies power for the operation of a mouse pointer sensor, a micro device and other components. Thus, both in the suspending mode and in operation, the mouse consumes the power from the battery. However, due to the limited electric voltage, the battery of the mouse is replaced when the mouse is used for a certain amount of time. Especially since the signal emitter and receiver of the mouse continuously consume power even when the user does not use the computer for a while.

### SUMMARY OF THE INVENTION

The primary objective of the present invention is to provide a power saving device comprising a sensor acting as a wake-up sensor. The sensor disconnects the power supply of a signal emitter so that the signal emitter does not need to continuously perform scanning when the mouse on which the signal emitter is mounted is in a suspending mode. In the meantime, a battery with a very small amount of power supplies power to the sensor. Thus, the life of the battery is increased significantly.

The power saving device of the present invention is disposed in the mouse and has at least one sensor both contacts of which connect to a battery and a signal emitter respectively, and one window disposed on an upper surface of a housing of the mouse. The sensor arranged in the mouse housing is disposed under the window and uses the battery as an operating power supply.

When the user holds the mouse and blocks the window, the sensor receives a correct signal reflected from the blocker and connects the operating power supply of the signal emitter to make the mouse operate normally. When the user does not use the computer for a while and the mouse is in a suspending mode, the sensor does not receive a correct signal and disconnects the operating power supply. Therefore, the signal emitter of the mouse does not need to perform scanning continuously. In the meantime, the battery, having a very small amount of power, supplies power to the sensor and, thus, the life of the battery is increased.

### BRIEF DESCRIPTION OF THE DRAWINGS

The foregoing and other features and advantages of the present invention will be more clearly understood from the following detailed description and the accompanying drawings, in which:

FIG. 1 is a perspective view showing a mouse of the present invention;

FIG. 2 shows the electrical connection of the sensor of the present invention

FIG. 3 is a block diagram showing the connection of the battery, the sensor and the signal emitter;

FIG. 4 shows the holding of a mouse;

FIG. 5 is a cross-sectional view showing that the sensor receives a correct signal reflected from a blocker when the user holds the mouse;

FIG. 6 shows that the sensor compares transmitted and received reflected signal

FIG. 7 shows the sensor receiving no reflected signal;

FIG. 8a shows a waveform produced by an ordinary sunlight lamp;

FIG. 8b shows a waveform received in the circumstances without a light source in the night;

FIG. 8c shows a waveform produced by a fluorescent lamp;

FIG. 8d shows a waveform sent by a emitter of the sensor; and

FIG. 9 shows a flow chart of the present invention.

### DETAILED DESCRIPTION OF THE PREFERRED EMBODIMENT

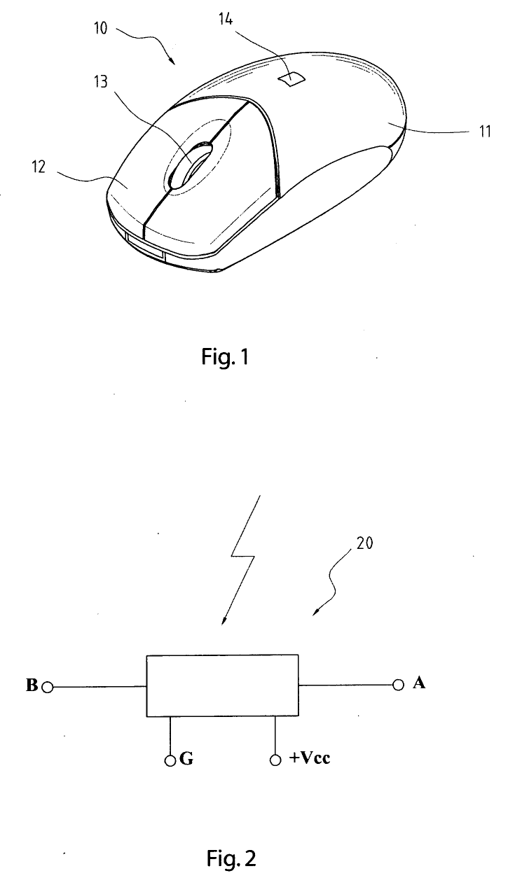

As shown in FIG. 1, the present invention provides a power saving device disposed in a wireless mouse 10. When the mouse 10 is in a suspending mode, the power saving device can decrease power consumption in order to increase the life of the battery.

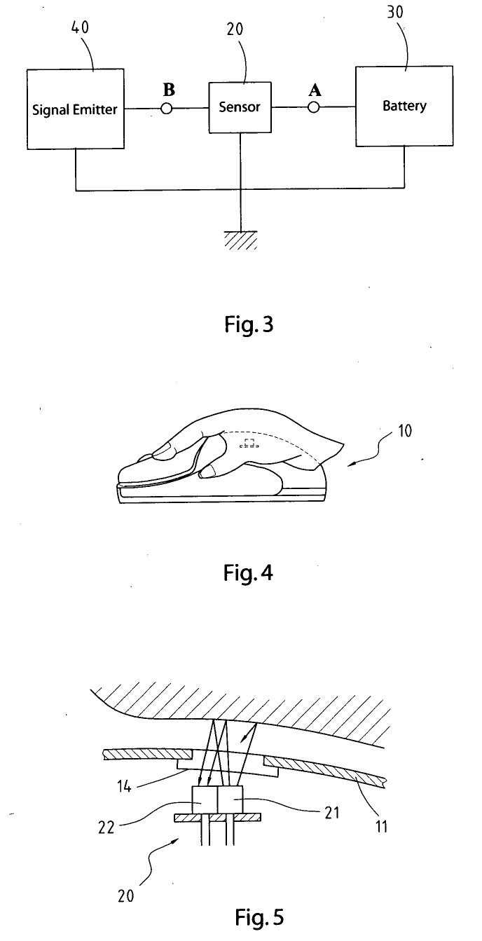

As shown in FIGS. 1 to 7, the mouse 10 has a plurality of buttons 12 and a scroll wheel 13 disposed at the front of housing 11. A window 14, which is transparent, is disposed on an upper surface of the housing 11. A signal emitter 40 is disposed in the housing 11 to send wireless signals for the operation of a computer. A set of batteries 30 is used to supply power to the mouse 10, as shown by the block diagram in FIG. 3.

As shown in FIGS. 2 and 3, the power saving device, disposed in the housing 11, comprises at least one sensor 20 having electrical contacts A and B, which connect to the battery 30 and the signal emitter 40, respectively. The sensor 20 is disposed under the window 14 of the housing 11 and uses the battery 30 as an operating power supply.

As shown in FIGS. 1 and 3, when the user's hand holds the mouse 10 and approaches to the window 14, the sensor 20 receives a correct induced signal and performs a wake-up action. That is, upon receiving the signal, the signal emitter 40 is connected to the operating power supply to make the mouse operate normally.

The sensor 20 has an emitter 21 and a receiver 22. A Wake-Up action is performed only when the light sent from the emitter 21 is reflected and the receiver 22 receives and identifies a light with the same waveform of the reflected light.

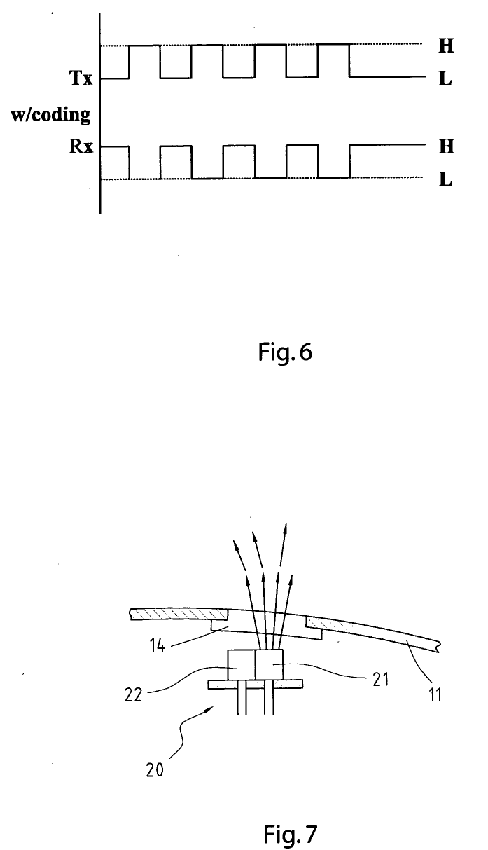

FIGS. 4, 5 and 6 show the sensor 20 receiving the correct induced signal. As shown in FIG. 5, when the user's hand holds the mouse 10 and approaches to the window 14, the signal sent by the emitter 21 of the sensor 20 is blocked by the hand and is reflected to the receiver 22 of the sensor 20. As shown in FIG. 6, the reflected signal is a correct signal if such reflected signal corresponds to the transmitted signal, and the sensor 20 then connects to the operating power supply of the signal emitter 40 to make the mouse operate normally.

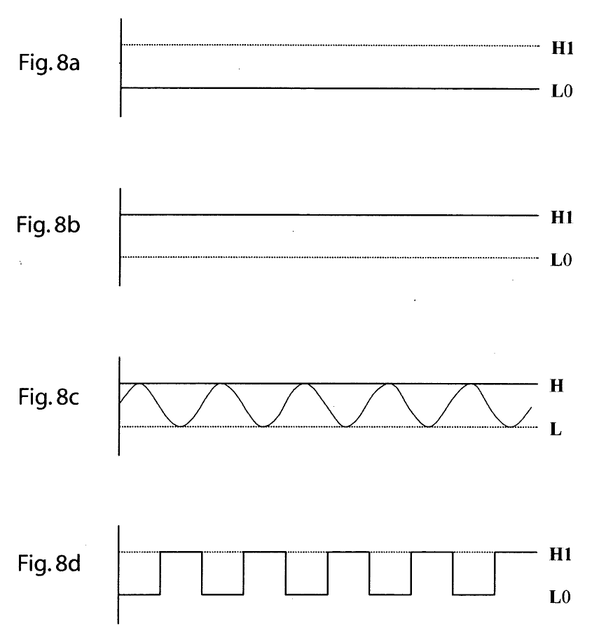

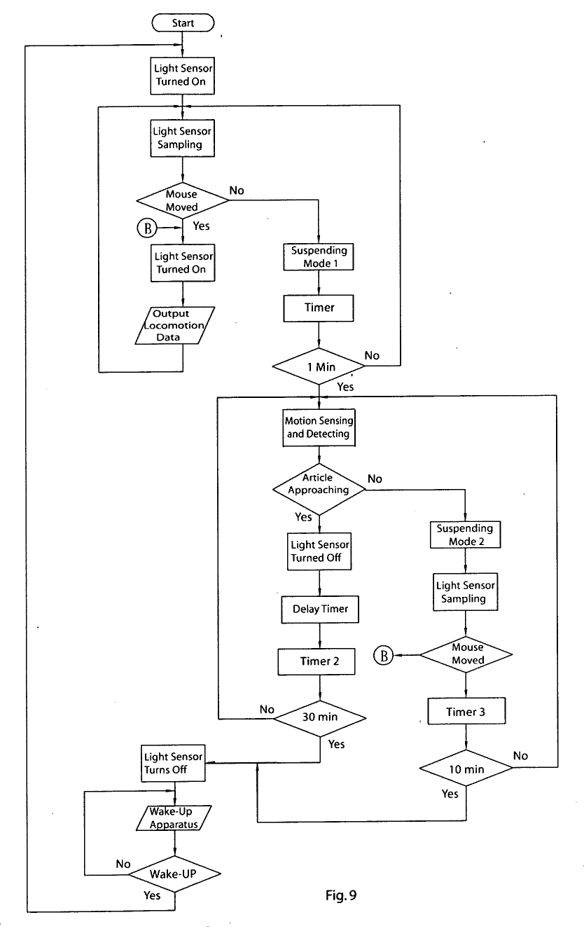

As shown in FIGS. 7, 8a, 8b and 8c, when the user does not use the computer for a while, the computer is in the suspending mode. Since the mouse 10 is not held, the signal sent by the emitter 21 of the sensor 20 is not blocked by the palm, nor reflected to the receiver 22 of the sensor 20. In this circumstance, receiver 22 does not receive any correct reflected signal. Even though external light with a waveform produced by a sunlight lamp (FIG. 8a), no light in the circumstances without a light source in the night (FIG. 8b), or fluorescent light from a lamp (FIG. 8c) is received, the receiver 22 of the sensor 20 will compare the waveform with the correct waveform (FIG. 8d). If the receiver 22 in the comparison identifies a different waveform, the sensor 20 does not connect to the operating power supply, and the signal emitter 40 is not supplied with power and does not perform scanning continuously. In the meantime, the battery 30 supplies the sensor 20 with a very small amount of power in the suspending mode, and, consequently, the life of the battery 30 is increased.

Since the remote Wake-Up action of a conventional wireless mouse is triggered by performing scanning once per second and needs more power, the life of the battery is decreased. With the power saving device of the present invention that uses the sensor 20 for the Wake-Up control, the consumption of the power is 100 times less than that of the prior art mouse. Further, the sensor 20 disconnects the power of the signal emitter 40 in the suspending mode so the mouse 10 does not need to perform scanning continuously any more. In the meantime, the battery 30, having a very small amount of power, supplies the sensor 20, and, consequently, the life of the battery 30 is increased.

With the sensor of the present invention, the power consumption of the mouse in the suspending and Wake-Up modes is lowered down to a minimum and the problem of power consumption of the prior art mouse is solved effectively. Further, the present invention has a special structure and is capable of increasing the life of the battery significantly.

Although the present invention has been illustrated and described with reference to the preferred embodiment thereof, it should be understood that it is in no way limited to the details of such embodiment but is capable of numerous modifications within the scope of the appended claims.

1. A power saving device disposed in a wireless mouse having a plurality of buttons and a scroll wheel disposed on a control end at the front of the housing of the mouse, a signal emitter being disposed in the housing to send wireless signals for the operation of a computer, and a set of batteries used as an operating power supply of the mouse, comprising:
a window disposed on an upper surface of said housing;
at least one sensor having a pair of contacts, said contacts connecting to said batteries and said signal emitter, respectively, said sensor being disposed under said window and using said batteries as an operating power supply, said sensor being triggered and connecting to said operating power supply when a user's hand is positioned above and external to the mouse, power to said signal emitter being disconnected when the user does not use said computer for a while, placing the mouse in a suspending mode, so that said signal emitter does not perform continuous scanning in order to conserve power drawn from said batteries.

2. A power saving device disposed in a mouse having a set of batteries used as an operating power supply of the mouse, comprising:
a window disposed on an upper surface of the housing of the mouse; and
at least one sensor connecting to said batteries. Said sensor emits signals and receives said signals blocked and reflected back to said sensor. After said sensor determines reflected signals corresponds to emitted signals, it activates said mouse in suspension mode and disconnected from said power supply.

3. The power saving device as claimed in claim 2, wherein said sensor comprises:
at least one emitter under said window to emit said emitted signals, and
at least one receiver under said window to receive said reflected signals.

4. The power saving device as claimed in claim 2, wherein said mouse is a wireless mouse.
